(19) United States
(12) Patent Application Publication
(10) Pub. No.: US 2007/0094865 A1
(43) Pub. Date: May 3, 2007

(54) Packaged thin film batteries and methods of packaging thin film batteries

(76) Inventors: Ji-Guang Zhang, Atlanta, GA (US); Eleston Maxie, Marietta, GA (US)

Correspondence Address: BAKER, DONELSON, BEARMAN, CALDWELL & BERKOWITZ, SUITE 3100 SIX CONCOURSE PARKWAY, ATLANTA, GA, 30328, US

(21) Appl. No.: 11/593,343

(22) Filed: Nov. 4, 2006

Related U.S. Application Data
(63) Continuation-in-part of application No. 10/047,407, filed on Jan. 10, 2002.

(51) Int. Cl. H01M 10/04; H01M 2/08

(52) U.S. Cl. 29/623.2; 29/623.3; 29/623.4; 429/185

(57) ABSTRACT

A packaged battery (60) is provided having a thin film lithium battery cell (62) sealed with a packaging foil or layer (67). The battery cell (60) includes a substrate (61) and an active cell (62) with an anode current collector (65) and a cathode current collector (64). The packaged battery is produced by heat sealing a packaging foil (67) to the exterior surfaces of the active cell (62).

### REFERENCE TO RELATED APPLICATION

This is a continuation-in-part of U.S. patent application Ser. No. 10/047,407 filed Jan. 10, 2002.

### TECHNICAL FIELD

This invention relates generally to thin film batteries, and more particularly to packaged thin film batteries and methods of packaging thin film batteries.

### BACKGROUND OF THE INVENTION

The metal lithium of thin film batteries reacts rapidly upon exposure to atmospheric elements such as oxygen, nitrogen, carbon dioxide and water vapor. Thus, the lithium anode of a thin film battery will react in an undesirable manner upon exposure to such elements if the anode is not suitably protected. Other components of a thin film battery, such as a lithium electrolyte and cathode films, also require protection from exposure to air, although these components are commonly not as reactive as thin metal anode films. It should therefore be desirable to incorporate within a lithium or lithium intercalation compound battery, which includes an anode of lithium and other air-reactive components, a packaging system that satisfactorily protects the battery components from exposure to air.

Polymer batteries have been constructed in a-manner in which the battery has a porous anode and cathode. The partially constructed battery cell is then placed within a protective “bag” which is sealed along three edges. Once the battery cell is positioned within the bag a liquid electrolyte is injected into the bag to occupy the space within the porous spacer between the anode and cathode. The open edge or forth edge of the bag is then heat sealed, as shown in U.S. Pat. No. 6,187,472. During the last steps of this process however air or other gases occupy spaces within the bag. These gases are entrapped within the bag once it is sealed. Much care must also be exercised during the sealing process to insure that the heat seal does not contact the battery cell within the bag as the heat will harm the polymer battery cell.

In the past packaging systems for batteries have been devised which included a shield which overlays the active components of the battery. These shields have been made of a ceramic material, a metallic material, and a combination of ceramic and metallic materials. The construction of thin film batteries however have proven to be quite difficult to produce and in providing an appropriate barrier as gas pockets may be capture between the anode and the protective layer during construction.

Another thin film battery packaging system has been devised wherein alternating layers of parylene and titanium are laid over the active components. The alternating layers are provided to restrict the continuation of pin holes formed in the layers during construction. This method of producing a protective layer has been difficult to achieve and has provided a protective layer which remains effective for only a short time.

It thus is seen that a need remains for a packaging system for thin film batteries which overcomes problems associated with those of the prior art. Accordingly, it is to the provision of such that the present invention is primarily directed.

### SUMMARY OF THE INVENTION

In a preferred form of the invention, a method of sealing a battery cell having a top surface and peripheral edges, the method comprising the steps of positioning a packaging foil over the top surface of the battery cell, and heat sealing the packaging foil to the top surface of the battery cell.

### BRIEF DESCRIPTION OF THE DRAWINGS

FIG. 1 is a cross-sectional side-view of a thin film battery cell.

FIG. 2 is an illustration of the complete thin film battery having a protective packaging illustrating principles of the invention in a preferred embodiment, shown prior to passing through the laminator.

FIG. 3 is a partial cross-sectional side-view of the thin film battery cell and a pair of packaging foils and carriers shown subsequent to passing through a laminator.

FIG. 4 is a cross-sectional side-view of the thin film battery cell and a pair of packaging foils in another preferred form of the invention.

FIG. 5 is a cross-sectional side-view of the thin film battery cell and a pair of packaging foils in another preferred form of the invention.

FIG. 6 is a cross-sectional side-view of the thin film battery cell and a pair of packaging foils in another preferred form of the invention.

FIG. 7 is a cross-sectional side-view of the thin film battery cell and a pair of packaging foils in another preferred form of the invention.

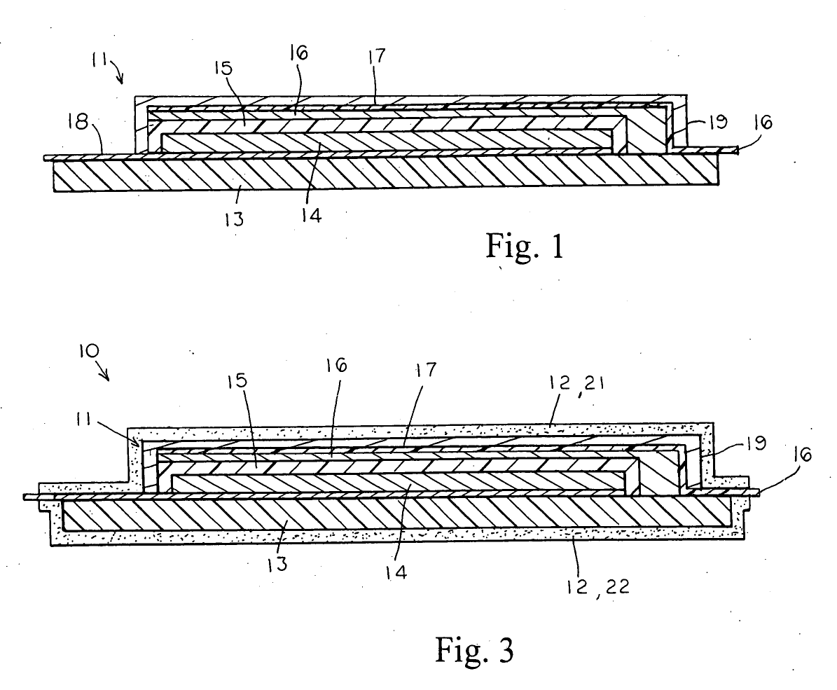

### DETAILED DESCRIPTION

With reference next to the drawings, there is shown in a packaged battery 10 embodying principles of the invention in a preferred form. The packaged battery 10 has a thin film lithium or lithium ion battery cell 11 encased within a packaging layer 12. The battery cell 11 includes a substrate 13, a cathode 14, an electrolyte 15, an anode 16, a passivation layer 19, a cathode anode current collector 18 and an anode current collector 17. The cathode 14 is made of a lithium metal or lithium intercalation compound, preferably a metal oxide such as LiNiO₂, V₂O₅, LiₓMn₂O₄, LiCoO₂ or TiS₂. The electrolyte 15 is preferable made of lithium phosphorus oxynitride, LiₓPO_{y}N_{z}. The anode 16 is preferably made of silicon-tin oxynitride, SiTON, when used in lithium ion batteries, or other suitable materials such as lithium metal, zinc nitride or tin nitride. Finally, an anode current collector 17 and cathode current collector 18 are preferably made of copper or nickel. The battery cell 11 is preferably manufactured in a manner described in detail in U.S. patent application Ser. No. 5,561,004, which is specifically incorporated herein.

With reference next to FIG. 3, to manufacture the battery 10 a bottom layer of packaging foil 21 is positioned to overlay the bottom surface of the substrate 13 while a top layer of packaging foil 22 is positioned to overlay the top surface of the passivation layer 19. The bottom and top layers of packaging foils 21 and 22 may be a laminated sheet of Class PPD or Class ECR packaging material made by Shield Pack, Inc. These packaging foils have an inward facing layer of polymer P1, an outwardly facing layer of polymer P2 and at least one intermediate layer of metal M, of course, the packaging foil may include several intermediate alternating layers of metal and polymer. A bottom sheet of carrier material 24 is positioned to overlay the bottom layer of packaging foil 21 while a top sheet of carrier material 25 is positioned to overlay the top layer of packaging foil 22. The carrier materials 24 and 25 may be 5 mil thick sheets of Kapton made by Dupont.

The battery cell 11, two layers of packaging foil 21 and 22, and two layers of carrier material 24 and 25 are then passed through a laminator having a pair of heaters 28 and a pair of pressure applying means in the form of lamination rollers 29. The packaging foils 21 and 22 become packaging layer 12 in the final product. The lamination rollers 29 are preferably made of a soft material such as rubber and are approximately 5 centimeter in diameter. The purpose of the carrier materials 24 and 25 is to provide an even pressure and temperature to the underlying packaging foil during the lamination process.

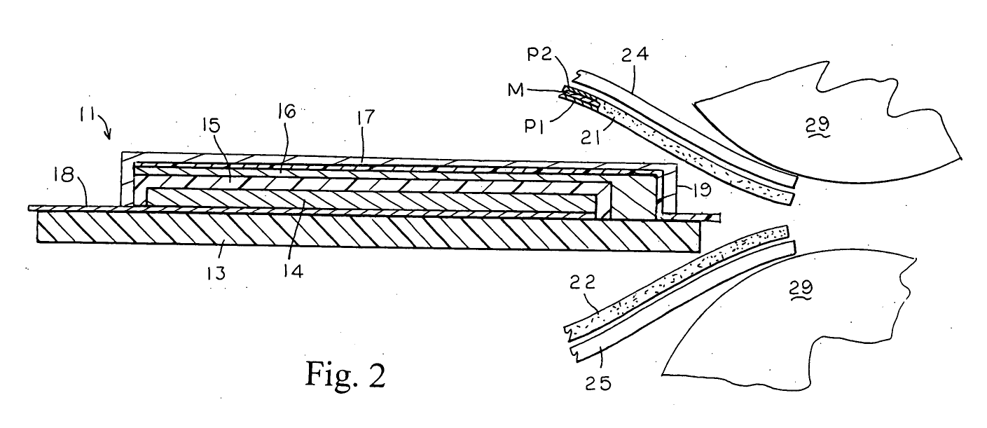

The temperature, pressure and rate of travel through the laminator causes the interior surface of the packaging foils 21 and 22 to be heat sealed to the corresponding surface of the battery cell 11 facing the packaging foils. As such, the interior surface of the bottom layer of packaging foil 21 is heat sealed to the bottom surface of the substrate 13 and the interior surface of the top layer of packaging foil 22 is heat sealed to the top surface of the passivation layer 19, as shown in FIG. 2. Although within the scope of the present invention many different combinations of temperature, pressure and material travel speeds through the laminator may be discovered which heat seals the packaging layers to the battery cell. However, it has been discovered that a temperature of 155 degrees Celsius, a pressure of 5 p.s.i and a travel speed of 25 cm/min for a Class PPD packaging material produces a proper heat seal between the packaging foils and the battery cell.

It has been discovered that by heat sealing the packaging foils directly to the battery cell the battery cell is provided with a substantially improved protective layer thereby improving the overall packaged battery. This improvement is achieved in part by the lamination process wherein as the packaging foils are heat sealed to the battery cell and as such occurs the gases between the foils and the battery cell are driven out. The use of packaging materials with the prior art batteries produced spaces between the battery cell and the packaging material, thereby allowing the capture of gases within these spaces which could degrade the components of the battery cell. The process of laminating the packaging material directly to the battery cell also creates a smaller overall battery, a problem which exists wherein the space occupied by the battery is intended to be as small as possible. Lastly, the lamination process causes the packaging material to be bonded to the side edges of the battery cell, thereby once again eliminating space between the battery cell and packaging material wherein harmful gases may in entrapped. This is enhanced by the softness and diameter of the lamination rollers 29 which determine the extent to which the packaging foil is forced against, and thereby sealed within, the side edges and inward corners of the battery cell.

It should be understood that while the present invention strives to laminate the exterior surfaces of the battery cell completely with the packaging material, the invention is not limited to such. However, it is desirous to laminate at least a majority of the top surface of the battery cell, the active material surface, so as to be in sealing engagement with the packaging foil, thereby eliminating virtually all gases therebetween. The packaging foil may be one sheet of packaging foil folded over itself or two separate sheets of packaging foil. Also, the laminating process may be carried out with the use of a platen laminator which consists of pressure applying means in the form of two oppositely disposed heated plates which are moved towards each other in pressing the material therebetween. The lamination process is considered to be a heat sealing process wherein the combination of heat and pressure causes a bonding of the packaging foil to the underlying cell.

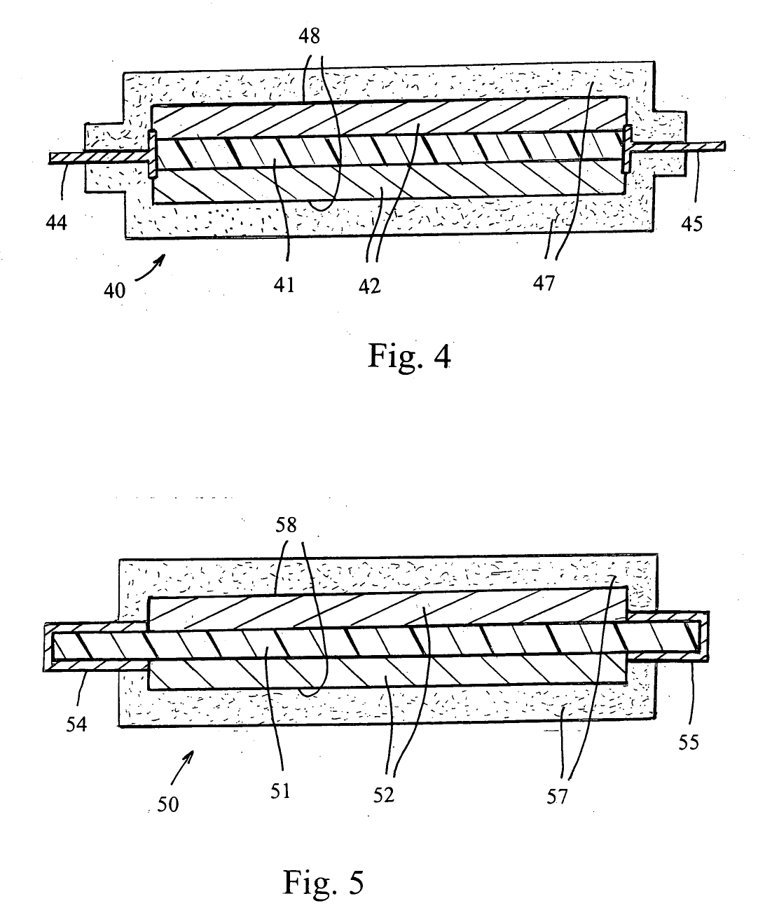

With reference next to FIG. 4, there is shown a battery cell 40 having a substrate 41 and active cells 42 on opposite sides of the substrate. Each active cell includes the typical cathode, electrolyte and anode. The cell also includes a cathode contact 44 and an anode contact 45. The packaging foil 47 is positioned on opposite sides of the battery cell 40 and heat sealed to the top surface 48 of each active cell 42. The packaging material is thereby bonded to a majority of the top surface 48.

With reference next to FIG. 5, there is shown a battery cell 50 having a substrate 51 and active cells 52 on opposite sides of the substrate. Each active cell includes the typical cathode, electrolyte and anode. The cell also includes a cathode contact 54 and an anode contact 55. The packaging foil 57 is positioned on opposite sides of the battery cell 50 and heat sealed to the top surface 58 of each active cell 52. The packaging material is thereby bonded to a majority of the top surface 58.

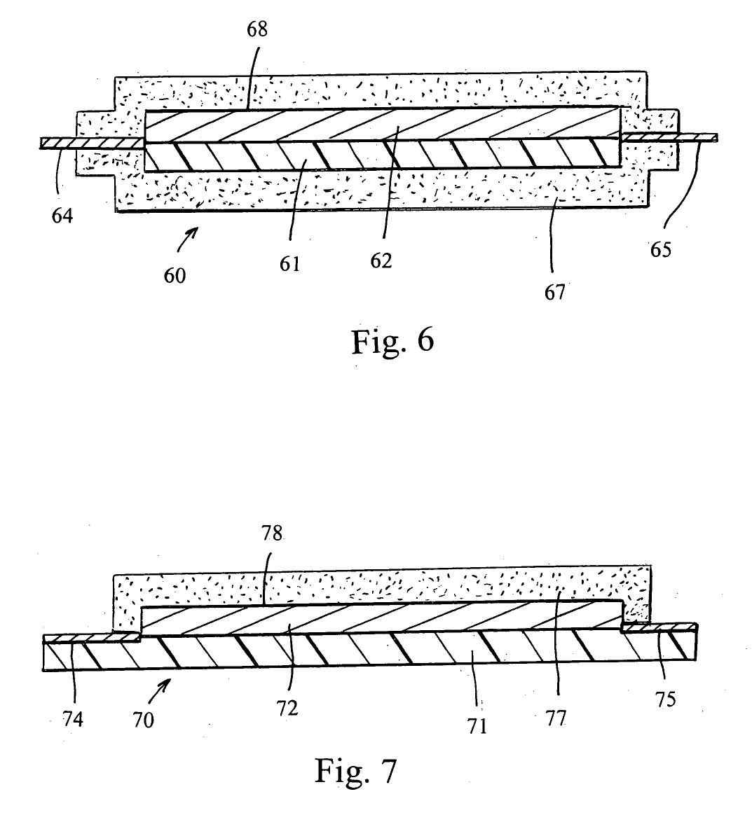

With reference next to FIG. 6, there is shown a battery cell 60 having a substrate 61 and an active cell 62. The active cell 62 includes the typical cathode, electrolyte and anode. The cell also includes a cathode contact 64 and an anode contact 65. The packaging foil 67 is positioned on the battery cell 60 and heat sealed to the top surface 68. The packaging material is thereby bonded to a majority of the top surface 68.

With reference next to FIG. 7, there is shown a battery cell 70 having a substrate 71 and an active cell 72. The active cell 72 includes the typical cathode, electrolyte and anode. The cell also includes a cathode contact 74 and an anode contact 75. The packaging foil 77 is positioned on the battery cell 70 and heat sealed to the top surface 78. The packaging material is thereby bonded to a majority of the top surface 78.

It should also be understood that the present invention is not limited to the use of lithium ion batteries and that the invention may be utilized with many types of thin film battery cells. Also, the arrangement of the cathode, electrolyte and anode may be inverted as compared to that shown in the drawings.

Lastly, it should be understood that the battery cell utilized in practicing the invention is not required to be passivated, as the packaging material can be heat sealed directly to the anode or anode current collector.

It thus is seen that a packaged battery is now provided which is sealed to prevent unwanted exposure to gases. It should of course be understood that many modifications may be made to the specific preferred embodiment described herein, in addition to those specifically recited herein, without departure from the spirit and scope of the invention as set forth in the following claims.

1. A method of sealing a battery cell having a top surface and peripheral edges, the method comprising the steps of:
(a) positioning a packaging foil over the top surface of a battery cell; and
(b) heat sealing the packaging foil to the top surface of the battery cell.

2. The method of claim 1 wherein said packaging foil is multi-layered laminates which includes at least one metallic layer and at least one polymer layer.

3. The method of claim 1 wherein step (b) the heat sealing is conducted in part by two oppositely disposed pressure applying means between which the packaging foil and battery cell are passed.

4. The method of claim 1 wherein step (b) the packaging foil is heat sealed to a majority of the top surface of the battery cell.

5. The product formed by the method of claim 1.

6. A method of sealing a battery cell having a top surface and peripheral edges, the method comprising the steps of:
(a) providing a layer of packaging foil;
(b) positioning packaging foil on top of a battery cell;
(c) heating the packaging foil; and
(d) pressing the packaging foil against the top surface of the battery cell so that the packaging foil is bonded to the top surface of the battery cell, whereby the heating and pressing of the packaging foil against the battery cell causes the packaging foil to be heat sealed to the battery cell.

7. The method of claim 6 wherein said packaging foil is a multi-layered laminate which includes at least one metallic layer and at least one polymer layer.

8. The method of claim 6 wherein step (d) the pressing of the packaging foils against the battery cell is conducted by two oppositely disposed pressure applying means between which the packaging foil and battery cell are passed.

10. The method of claim 6 wherein step (d) the first layer is sealed to a majority of the top surface of the battery cell.

11. The product formed by the method of claim 6.
